(19) United States
(12) Patent Application Publication
(10) Pub. No.: US 2016/0296060 A1
(43) Pub. Date: Oct. 13, 2016

(54) PROCESS AND ASSEMBLY FOR FORMULATING A FOOD PRODUCT

(71) Applicant: TETRA LAVAL HOLDINGS & FINANCE S.A., Pully (CH)

(72) Inventor: Håkan PÅLSSON, Svedala (SE)

(73) Assignee: TETRA LAVAL HOLDINGS & FINANCE S.A., Pully (CH)

(21) Appl. No.: 15/038,253

(22) PCT Filed: Nov. 19, 2014
(86) PCT No.: PCT/EP2014/075017

§ 371 Date: May 20, 2016

(30) Foreign Application Priority Data
Nov. 22, 2013 (SE) 1351395-7

(51) Int. Cl. A47J 31/40; A23C 9/152; A23C 9/15

(52) U.S. Cl. CPC A47J 31/401; A23C 9/15; A23C 9/152

(57) ABSTRACT

A process and an assembly for formulating a liquid food product are provided. The process comprises the steps providing a slurry of food solids, said slurry being prepared by mixing food powder and liquids with water, blending and standardizing the slurry by in-line injection of water and additional ingredients, and heat treating the formulated liquid food product. The blending and standardization step and heat treatment step may be continuous.

### TECHNICAL FIELD

The present disclosure relates to a process and an assembly for formulating a food product from mainly water, powder, sugar and additional ingredients.

### TECHNICAL BACKGROUND

Processes and assemblies for formulating food products have been in use for many years within the dairy industry. Traditionally batch process with many storage tanks and process steps has been used in order to formulate the food product. The main benefit of the traditionally batch process is that it is a common knowledge and technology, it is the industry standard and customer is confident in the batch process and thereby setting up their production and recipes accordingly.

Batch processes may be very energy consuming, since large volumes of product are heated and cooled; in batches. The accuracy of a standardised product, such as milk can also vary distinctly from batch to batch. Batch processes also may require a large floor space for the many and large storage tanks that generally are involved.

### SUMMARY

It is hence an object to eliminate or alleviate some of the drawbacks of the prior art.

According to a first aspect it is provided a process for formulating a liquid food product, comprising the steps of providing a slurry of food solids, said slurry being prepared by mixing powder and liquid ingredients with water, blending the slurry by in-line injection of water and additional liquid ingredients, then heat treating the formulated liquid food product. The blending step and heat treatment step may be continuous.

In one or several embodiments the slurry may comprise more than 25 percent by weight of food solids.

According to one or more aspects water and/or additional ingredients may be added by in-line injection in connection with the blending and standardization step.

Additional ingredients may also or instead be added by in-line injection in connection with the UHT step, before the aseptic storage step or before the filling step

According to another aspect the mixing step may be performed in the presence of a vacuum, for simultaneous deaeration of the food product being mixed.

The mixing step may in one or several embodiments be carried out at a temperature of between 20° C. and 60° C., and the storing step may in the same or other embodiments be carried out at a temperature of between 20° C. and 60° C.

The food solids may comprise whole milk powder, and it may also comprise stabilizer, sugar and additional ingredients in combination or as separate and optional components. The additional ingredients may in one or several embodiments comprise lactic acid and or citric acid.

According to a second aspect it is provided an assembly for formulating a food product according to the process of the first aspect, comprising a storage tank for receiving a mixed food slurry, a blending unit for in-line injection of water and additional liquid ingredients, and a heat treatment unit. The blending unit and the heat treatment unit may be configured to be operated continuously.

The assembly may further comprise a mixer for mixing water with food powder and liquids, in any embodiment of the present invention

The heat treatment unit may be an ultra high temperature (UHT) heat treatment unit.

The mixer may be connected to a vacuum source, for removing air from a mixing tank of the mixer.

The mixer may be a high-shear mixer.

An additional unit may be arranged in connection with the blending unit, UHT unit, before the aseptic storage tank or the aseptic filling machine, for in-line injection of ingredients.

At least one of the units for in-line injection of ingredients may comprise a positive displacement pump, such as a piston pump, for accurate dosing.

### BRIEF DESCRIPTION OF THE DRAWINGS

The present invention will be more readily understood when read in conjunction with the appended drawings, in which

FIG. 1 is a schematic representation of a process for formulating milk product according to prior art,

FIG. 2 is a schematic representation of a process for formulating milk product according to one embodiment, and

FIG. 3 is a schematic representation of an assembly for carrying out the process according to one embodiment.

### DETAILED DESCRIPTION

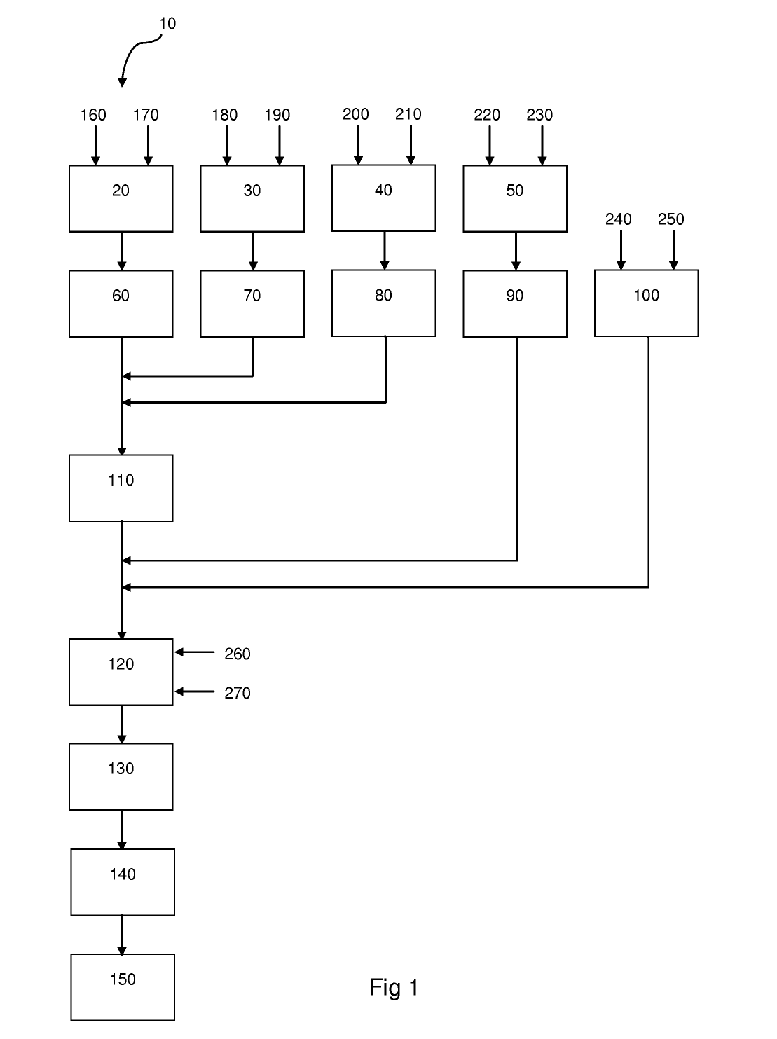

The normal formulation process 10 can be seen in FIG. 1. In several parallel preparation processes step 20-50 and 100 the powder or liquid ingredients are prepared and then stored in step 60-100 for further processing. In step 20-50 the powder ingredients 160, 180, 200 and 220 are mixed with water (4-85° C.) 170, 190, 210 and 230 under circulation over a storage tank in step 60-90 until the mixture reaches its final composition and homogeneity. The mixture is then held during a storing step 60-90 for hydrating and maturing of the mixture before further processing. In step 100 dry or liquid ingredients 240 are blended with water 250 in a storage tank until the mixture reaches its final composition and homogeneity. The mixture is then held during a storing step 100 before for further processing.

The formulation process the starts with that the mixture from one storage tank in step 60 is pumped forward and then the mixture from one storage tank in step 70 is added, then the mixture from step 80 is added before the mixture is cooled (from 25° C. to 6-8° C.) in step 110. After step 110 the mixture from one storage tank in step 90 is added and then the mixture from one storage tank in step 100 is added and the final mixture arrives to a tank in the intermediate storage step 120. In intermediate storage step 120 the mixtures protein content is standardized by adding water 260 and depending on recipe, flavours or additional ingredients 270 are added.

The formulated product is then brought to a UHT heat treatment unit in a UHT heat treatment step 130, and is subsequently pumped to an aseptic storage tank 140 and then to an aseptic filling machine 150, for being packaged,

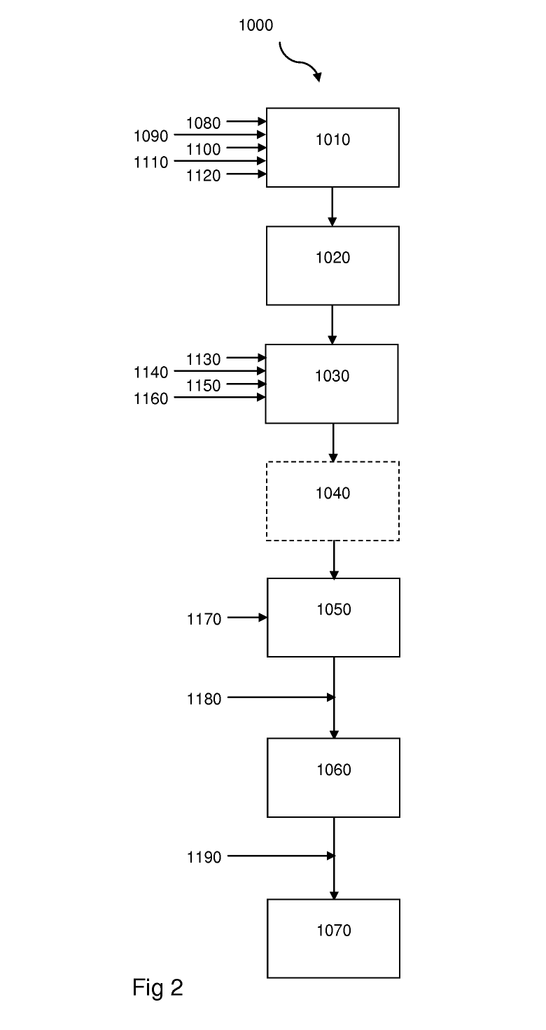

The process according to one embodiment of the present invention is shown schematically in FIG. 2. It should be emphasized that the process as depicted includes a number of optional steps, and consequently it actually includes a number of embodiments. The process 1000 for the formulation of a milk product from water, whole milk powder, stabilizer, sugar and additional ingredients starts with a first mixing step 1010 in a vacuum mixer, such as Tetra Almix from Tetra Pak®, where heated water (20-60° C.) 1080 is fed to the vacuum mixer at ambient pressure. The whole milk powder 1090, stabilizer 1100, sugar 1110 and additional ingredients 1120 are then fed into the vacuum mixer when the operational water level and the desired vacuum pressure are achieved. Under the vacuum pressure, a preset amount of the ingredients 1080-1120 is transferred into the vacuum vessel, under strong shear from a mixing head inside the vessel, until a milk solid content of about 20-60% is achieved.

This will form a well mixed slurry with a milk solid content of 20% to 60%. When all the ingredients has been added, the vacuum mixer will perform a low shearing/blending action of the slurry at a low vacuum pressure, with the aim to remove air absorbed in the ingredients (a milk powder contains approximately the same volume of air as volume of powder). The vacuum pressure will be applied until such time that the air content is reduced to a minimum, which may be determined by measurement or empirical data.

Optionally, this first step can be performed off-line, and the process then starts with providing a ready-mixed slurry of high solid content (20% to 60% by weight).

Upon completion of the above mixing step, the slurry is pumped with a high capacity pump to one or several intermediate buffer tanks, in a storage step 1020. The function of the buffer tanks is to supply a continuous supply of slurry to the subsequent units. Product from the buffer tanks can be fed directly to the blending and standardization unit 1030 upon end of the transfer from the vacuum mixer. The slurry could optionally also stay in the tanks for a certain minimum time, for hydration or maturing.

The next step is a blending and standardization step 1030 where an in-line injection of water 1130 is added to the slurry together with lactic acid 1140, citric acid 1150 and any additional ingredient 1160, if desired. All the ingredients are added through an in-line injection unit; blending and standardizing the milk product into a uniform liquid product. One such type of in-line injection unit is the Tetra Alfast from Tetra Pak®.

The milk product is optionally passing through an in-line shearing unit in step 1040. This will facilitate a shear treatment of the milk product to ensure it is emulsified and homogenous. One such type of in-line shearing unit is the Tetra Almix from Tetra Pak®.

Subsequently, the finished milk product is sterilized in a sterilization step 1050 of ultra high temperature (UHT) heat treatment, before being sent to an aseptic storage tank step 1060 and then to a aseptic filling machine step 1070 for filling. This sterilization step 1050 efficiently sterilizes the milk product, for achieving long shelf life when aseptically filled and packaged in the filling machine. The UHT heat treatment can be performed in a Tetra Therm Aseptic Flex or Tetra Therm Aseptic VTIS, both from Tetra Pak®. Other downstream steps are also possible, such as filtration, homogenization etc. in order to prepare a milk product of desired quality.

In one or more embodiments, additional ingredients may instead be in-line injected before or after the homogenizer in sterilization step 1050 depending on type of ingredient and desired product quality

In still other embodiments additional aseptic ingredients may be aseptic in-line injected before the aseptic storage step 1060 or the aseptic filling machine step 1070. One such type of aseptic in-line injection unit is the Tetra Aldose or Tetra FlexDos from Tetra Pak®

One effect of the present disclosure according to one or more embodiments is that a slurry is used, which slurry later on in the process is blended to final product. Another effect is that the process is continuous after the storage step 1020 in storage tank. This greatly enhances the speed of the process, and greatly reduces the need for additional tanks for storage of the product.

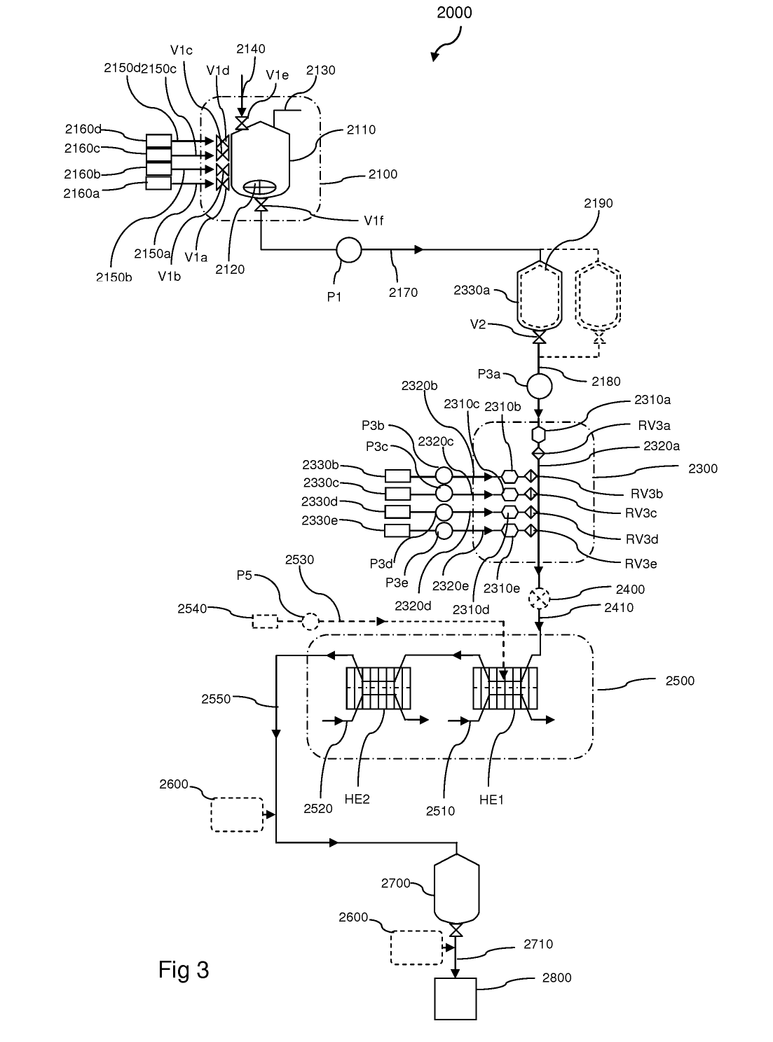

In FIG. 3 an example of an assembly 2000 for formulating a milk product according to the above process is shown. The assembly comprises a vacuum mixer 2100 which is provided with a high shear mixer in a mixing head 2120 in the bottom of a mixing vessel 2110. Whole milk powder, stabilizer, sugar and additional dry or liquid ingredients are added to the mixing vessel from silos/tanks 2160a-d through pipes 2150a-d and valves V1a-d by the vacuum from the mixer. Water is added through pipe 2140 and valve V1e. The mixing vessel 2110 is further supplied with a vacuum pressure via pipe 2130, which is connected to a vacuum source (not shown). The mixing head 2120 may be driven at a low speed during the deaeration phase of the mixing step. After completion of the mixing step, the bottom valve V1f of the mixer 2100 leads the milk slurry from the mixing vessel towards a buffer tank 2330a through pipe 2170 with the use of pump P1. Several buffer tanks may be arranged in parallel, in order to ensure continuous operation, downstream of the buffer or storage tank 2330a.

Optionally, the buffer tank 2330a may have an inner jacket 2190, shown as dashed line, allowing a heating or cooling medium to be supplied between the jacket and the outer shell. After being stored in the buffer tank 2330a, valve V2 is opened, leading the milk slurry through pipe 2180 to the blending and standardization unit 2300 via pump P3a.

The blending and standardization unit 2300 comprises, in the shown example, five similar ingredient lines, each line comprising a regulation valve RV3a-e, a measuring instrument 2310a-e and a pipe 2320a-e. The measuring instrument type can e.g. be a flow transmitter, a mass flow transmitter or a density transmitter or a combination of these transmitters to suit the property of the ingredient. The measuring instruments 2310a-e should be accurate enough to permit accurate measurement of the ingredient, and the regulation valves RV3a-e should be accurate enough to permit accurate in-line injection of the ingredients.

To each ingredient line in the blending and standardization unit 2300 a tank 2330a-e and a pump P3a-e (centrifugal type) are connected.

Optionally, the centrifugal pump other pump type can be used to suit the property of the ingredient, the pump type need to be rather accurate to permit accurate in-line injection of the ingredients. The pump type can e.g. be a positive displacement proportioning pump, such as a piston pump or a mechanically powered diaphragm pump.

The line 2320a, 2310a, P3a, 2330a delivers a milk slurry from a tank 2330a via pump P3a through a measuring instrument 2310a and pipe 2320a leading the milk slurry into a regulation valve RV3a.

The line 2320b, 2310b, P3b, 2330b delivers water from a tank 2330b via pump P3b through a measuring instrument 2310b and pipe 2320b leading the water into a regulation valve RV3b.

The line 2320c, 2310c, P3c, 2330c delivers lactic acid from a tank 2330c via pump P3c through a measuring instrument 2310c and pipe 2320c leading the lactic acid into a regulation valve RV3c.

The line 2320d, 2310d, P3d, 2330d delivers citric acid from a tank 2330d via pump P3d through a measuring instrument 2310d and pipe 2320d leading the citric acid into a regulation valve RV3d.

The line 2320e, 2310e, P3e, 2330e delivers additional ingredients from a tank 2330e via pump P3e through a measuring instrument 2310e and pipe 2320e leading the additional ingredients into a regulation valve RV3e.

In this way, the milk slurry of 20-60% by weight of milk solids is now blended and standardized to a desired product specification, with desired fat, protein, total solids, sugar and other content and with additional ingredients, e.g. taste substances.

Optionally depending on the milk product specification and properties it will pass through a high shear unit 2400, shown with dashed lines for additional treatment of the milk product. The high shear unit will emulsify the milk product in order to ensure a homogenous milk product.

The thus formulated milk product is thereafter pumped through a UHT heat treatment unit 2500, shown schematically in FIG. 3. The UHT heat treatment unit typically may comprise two heat exchangers HE1, HE2, where the first heat exchanger HE1 is connected to a heating source (such as steam) 2510, for bringing the milk product to a very high temperature, typically >137° C. This high temperature is only held for a couple of seconds, not to change the properties too much of the milk product, and is thereafter cooled in the second heat exchanger HE2, being connected to a cooling source 2520. The milk product is now sterilised and can be pumped onwards via pipe 2550 to aseptic storage, in an aseptic tank 2700 and then to an aseptic filling machine 2800 via pipe 2710, to be packed in aseptic packages. The heat treatment unit 2500 can be another type of heat treatment unit, e.g. a pasteuriser, and it can also be a unit for direct heating with steam injection, with subsequent flash cooling by expansion of the steam in low pressure, according to well-known techniques.

Optionally depending on the milk products specification additional ingredients can be in-line injected before or after the homogeniser (not shown) in the heat treatment unit 2500 by the means of the line 2540, P5 and 2530, shown by dashed lines delivers additional ingredients from a tank 2540 via pump P5 through pipe 2530 leading the additional ingredients into the heat treatment unit 2500.

Optionally depending on the milk products specification additional aseptic ingredients can be aseptic in-line injected in the pipe 2550 before the aseptic storage tank 2700 and/or in the pipe 2710 before the aseptic filling machine 2800 by the means of aseptic dosing unit 2600, shown by dashed lines.

With the process and assembly of embodiments of the present invention, a very concentrated food slurry may be mixed and deaerated. By having a more concentrated food slurry, less energy is required for heating and cooling later in the process. Further a much less and smaller buffer/storage tank is required for the storage. By preparing a more concentrated food slurry at the initial stage of the process, the flexibility of the line increases as well.

The in-line blending, standardization and dosing of all ingredients can be obtained with a very high precision and repeatability, with savings on ingredients and energy. Furthermore, on line change of recipe/product can be obtained in conjunction with the automation of the remaining heat treatment and filling equipment.

The above assembly and process is described for the formulation of a milk product. However, the same general principles apply for the formulation of similar products that are made from a solid powder as the base material. Such products are e.g. soy milk, oat milk, certain soups, sauces, custards and fruit or vegetable drinks. In spirit with the invention, these products can also be formulated by first making or providing slurry with a high content of solids, with subsequent continuous blending, standardization and heat treatment, storing etc., in accordance with the invention. It is also possible to use the process and assembly of the invention for producing other dairy products containing milk, such as flavoured milk, recombined milk and similar.

The detailed description shows how to prepare a slurry of high solid content. It is however possible to start the process with a ready-made slurry of high solid content, without deviating from the main features of the invention.

The invention has mainly been described above with reference to a few embodiments. However, as is readily appreciated by a person skilled in the art, other embodiments than the ones disclosed above are equally possible within the scope of the invention, as defined by the appended patent claims.

1. A process for formulating a liquid food product, comprising the steps of
providing a slurry of food solids, said slurry being prepared by mixing food powder and liquids with water,
blending and standardizing the slurry by in-line injection of water and
heat treating the formulated liquid food product,
wherein the blending and standardizing step and heat treatment step are continuous.

2. The process according to claim 1, wherein the slurry comprises more than 25 percent by weight of food solids.

3. The process according to claim 1, wherein water and/or additional ingredients are added by in-line injection in connection with the blending and standardizing step.

4. The process according to claim 1, further comprising a in-line shearing step prior to the heat treatment step.

5. The process according to claim 1, wherein the mixing step is performed in the presence of a vacuum, for simultaneous deaeration of the food product being mixed.

6. The process according to claim 1, wherein the mixing step is carried out at a temperature of between 20° C. and 60° C., and the storing step is carried out at a temperature of between 20° C. and 60° C.

7. The process according to claim 1, wherein the food solids are whole milk powder.

8. The process according to claim 1, wherein additional ingredient can be in-line injected in the heat treatment step and/or prior to the aseptic storage step and/or prior to the aseptic filling machine.

9. The process of claim 1, wherein the food solids are selected from the group comprising whole milk powder, stabilizer and sugar, or any combination thereof.

10. The process of claim 3, wherein the additional ingredients comprise a selection from the group comprising lactic acid and citric acid, or a combination thereof.

11. An assembly for formulating a food product according to the process according to claim 1, comprising
a storage tank for receiving a mixed food slurry,
a blending and standardization unit for in-line injection of water, and
a heat treatment unit,
wherein the blending and standardization unit and the heat treatment unit are configured to be operated continuously.

12. An assembly according to claim 11, further comprising a mixer for mixing water with food powder and liquids.

13. An assembly according to claim 11, wherein the heat treatment unit is an ultra high temperature heat treatment unit.

14. An assembly according to claim 11, wherein the mixer is connected to a vacuum source, for removing air from a mixing vessel of the mixer.

15. An assembly according to claim 11, wherein an in-line shear unit is arranged between the blending and standardization unit and the heat treatment unit.

16. An assembly according to claim 11, wherein the mixer is a high-shear mixer.

17. An assembly according to claim 11, wherein an additional unit is arranged in connection with the blending and standardization unit and/or an additional unit is arranged in connection with the heat treatment unit and/or an additional aseptic unit prior to the aseptic storage unit and/or prior to the aseptic filling machine for in-line injection of additional ingredients.

18. An assembly according to claim 11, wherein at least one of the units for in-line injection of liquid ingredients may comprises a positive displacement pump, such as a piston pump, for accurate dosing.
